(19) United States
(12) Patent Application Publication
(10) Pub. No.: US 2022/0267627 A1
(43) Pub. Date: Aug. 25, 2022

(54) Photothermally Responsive Melanin-Based Nanocomposltes

(71) Applicants: Ali Dhinojwala, Akron, OH (US); Mario Echeverri, Northfield, OH (US); Anvay Arun Patil, Cuyahoga Falls, OH (US)

(72) Inventors: Ali Dhinojwala, Akron, OH (US); Mario Echeverri, Northfield, OH (US); Anvay Arun Patil, Cuyahoga Falls, OH (US)

(73) Assignee: THE UNIVERSITY OF AKRON, AKRON, OH (US)

(21) Appl. No.: 17/549,099

(22) Filed: Dec. 13, 2021

Related U.S. Application Data
(60) Provisional application No. 63/148,305, filed on Feb. 11, 2021.

(51) Int. Cl. C09D 11/17; C09D 5/26; C09D 163/00; C09D 7/41; C09D 7/65; C09D 7/40; B42D 25/382

(52) U.S. Cl. CPC C09D 11/17; C09D 5/26; C09D 163/00; C09D 7/41; C09D 7/65; C09D 7/67; C09D 7/68; B42D 25/382

(57) ABSTRACT

In various embodiments, the present invention is directed to photothermal-responsive melanin-based nanocomposites comprising a plurality of natural or synthetic melanin nanoparticles distributed with a polymer matrix suitable for use in anti-counterfeiting, photothermal responsive-communication, sensors, and heat management, among other applications. In some embodiments, the present invention will be an ink, paint, or other coating comprising the photothermal-responsive melanin-based nanocomposites. In some embodiments, the present invention is directed to a written message or design comprising one or more of the photothermal-responsive melanin-based nanocomposites. In some of these embodiments, the written message or design will be comprised of two ore more of the photothermal-responsive melanin-based nanocomposites having different concentrations of natural or synthetic melanin nanoparticles.

### CROSS REFERENCE TO RELATED APPLICATIONS

This application claims the benefit of U.S. provisional patent application Ser. No. 63/148,305 entitled “Photothermally Responsive Melanin-Based Nanocomposites,” filed Feb. 11, 2021, and incorporated herein by reference in its entirety.

### STATEMENT REGARDING FEDERALLY SPONSORED RESEARCH OR DEVELOPMENT SUPPORT

This invention was made with government support under FA-9550-18-1-0142 awarded by United States Air Force Office of Scientific Research. The government has certain rights in the invention.

### FIELD OF THE INVENTION

One or more embodiments of the present invention relates to a photothermally responsive nanocomposites. In certain embodiments, the present invention is directed to melanin-based photothermally responsive nanocomposites.

### BACKGROUND OF THE INVENTION

Melanin is a well-known ubiquitous biomaterial present in almost all living organisms. Although notorious for its chemical complexity and structural diversity, this enigmatic biomaterial possesses multifunctional properties like structural coloration, photoprotection, metal-ion chelation, and more recently, thermoregulation, which attract interests from diverse disciplines. In particular, melanin's two unique optical properties have been of immense interest in the past decade: (a) high refractive index (1.7-1.8) and (b) broadband absorption, primarily responsible for providing structural coloration, protection against UV radiation, and thermoregulation in the animal kingdom.

The role of melanin in thermoregulation has been a new avenue of exploration for scientists. Typically, melanin-induced thermoregulatory process in living organisms is characterized by conversion of solar energy to thermal energy, owing to its broadband photo-absorption behavior. Melanin-rich body parts like wing scales of lepidopterans have aided in their adaptation to the climatic conditions at high latitudes/altitudes by faster warm-up times and wings of ospreys have contributed towards their flight efficiency by modulating wing surface temperature to reduce skin friction drag. Interestingly, recent evidence has also shown that deep-sea fishes have developed an ultra-black camouflage in the advent of protecting themselves from visual predators by optimizing the size and shape of the melanosomes (melanin-containing organelles) in the skin to minimize reflectance in the bioluminescent wavelengths to near-zero. Following melanin's history of photo-absorption for thermoregulatory processes, some researchers share an alternative school of thought which suggests this highly-loaded layer of melanin in deep-sea fishes could also contribute to regulate their own body temperature.

Natural melanins, produced via the melanogenesis of tyrosine in specialized cells called melanocytes or melanophores, exist as randomly close-packed structures in a matrix such as keratin or chitin. This makes it challenging to extract natural melanin in their pure form in copious amounts and involves a cumbersome multi-step process, thereby limiting their use for practical applications. Thus, synthetic mimics like dopamine (DA), with a chemical structure similar to tyrosine, have been widely used as a starting material to produce synthetic melanin with similar properties to natural melanin for practical purposes.

Natural melanins, produced via the melanogenesis of tyrosine in specialized cells called melanocytes or melanophores, exist as randomly close-packed structures in a matrix such as keratin or chitin. This makes it challenging to extract natural melanins in their pure form in copious amounts and involves a cumbersome multi-step process, thereby limiting their use for practical applications. Thus, synthetic mimics like dopamine (DA), with a chemical structure similar to tyrosine, have been widely used as a starting material to produce synthetic melanin with similar properties to natural melanin for practical purposes.

Self-polymerized DA, polydopamine (PDA), have been widely employed as coatings to modify the surface of various materials owing to its adhesive nature and as particles for multi-purpose applications ranging from structural colors, catalysis, fillers to theranostics. Little has been studied about using PDA particles as a polymer filler in nanocomposites, but its unique ability to be dispersed in a wide variety of polymeric materials opens an avenue for novel applications including photothermally responsive materials for anti-counterfeiting or localized heat management.

Self-polymerized DA, polydopamine (PDA), have been widely employed as coatings to modify the surface of various materials owing to its adhesive nature and as particles for multi-purpose applications ranging from structural colors, catalysis, to theranostics. Little has been studied about using PDA particles as a polymer filler in nanocomposites, but its unique ability to be dispersed in a wide variety of polymeric materials opens an avenue for generation of composites with new functional properties. Recently, a combined experimental and simulation study on photothermal absorption in iridescent feathers of sunbird species found that greater the melanin content in feather barbules, greater the photothermal absorption and heat loads.

What is needed in the art is a photothermal-responsive melanin-based nanocomposites comprising a plurality of natural or synthetic melanin nanoparticles and a polymer matrix suitable for use in anti-counterfeiting, photothermal responsive-communication, sensors, and heat management, among other applications.

### SUMMARY OF THE INVENTION

In one or more embodiments, the present invention provides a photothermal-responsive melanin-based nanocomposite comprising a plurality of natural or synthetic melanin nanoparticles and a polymer matrix suitable for use in anti-counterfeiting, photothermal responsive-communication, sensors, and heat management, among other applications. As set forth above, melanin and its synthetic mimics are known to exhibit photothermal absorption behavior and will differentially heat when exposed to light. Synthetic melanin nanoparticles (like PDA) can be easily loaded in many polymeric materials (like polystyrene, acrylates, epoxies, polyurethanes, poly(lactic acid), polyolefins, polysiloxanes (PDMS), rubbers and elastomers) using common and benign solvent for the polymeric matrix and for PDA dispersion where necessary to fabricate the substantially homogeneously filled polymeric nanocomposite materials. Advantageously and unlike metals, lanthanides, or other toxic fillers for polymeric materials, use of synthetic melanin nanoparticles as fillers does not render these nanocomposites toxic or otherwise harmful to humans and environment. In various embodiments, the thermal radiative properties of the nanocomposite may easily be controlled by tuning the concentration of the melanin or synthetic melanin (e.g., PDA) nanoparticles dispersed into the polymeric matrix.

Similarly, the easy dispersibility of natural or synthetic melanin nanoparticles during filler loading and the malleability/compliance of the PDA-loaded polymeric matrix allows for numerous intricate patterns and designs to be fabricated and broadband absorption of natural and synthetic melanin across the UV-visible region of the electromagnetic spectrum allows for the generation of very dark nanocomposites which are unidentifiable to the naked eye even at varying concentration loadings. Moreover, since synthetic melanin nanoparticles are very easy to disperse into polymers, in some embodiments of the present invention, they can readily be loaded into polymer melts and mixed via the shearing processes (extrusion, brabenders, two-roll mills, rubber mills). In some other embodiments, the synthetic melanin nanoparticles can be dispersed into paint vehicles to yield recipes for ink and paint formulations that are photothermally responsive. This characteristic facilitates fabrication of embedded patterns invisible to the naked eye. In one or more embodiments, differential photothermally-absorbed regions can be achieved using different loading concentrations of PDA in a single area (high loading concentration for the embedded design and low for the surrounding) yielding a significant temperature difference between the two upon exposure to solar IR lamp radiation. A thermal camera can be used to show this difference, making the hidden pattern visual.

In a first aspect, the present invention is directed to a photothermal-responsive melanin-based nanocomposite comprising a plurality of natural or synthetic melanin nanoparticles and a polymer matrix wherein the temperature of the nanocomposite increases when it is exposed to light. In one or more embodiment, the plurality of natural or synthetic melanin nanoparticles comprises polydopamine (PDA) nanoparticles. In one or more embodiments, the photothermal-responsive melanin-based nanocomposite of the present invention includes any one or more of the above referenced embodiments of the first aspect of the present invention wherein the polymer matrix is selected from the group consisting of epoxy, polystyrene, acrylates, polyurethanes, poly(lactic acid), polyolefins, vinyls (polyvinyl alcohol), polysiloxanes (PDMS), rubbers and elastomers, and combinations thereof.

In one or more embodiments, the photothermal-responsive melanin-based nanocomposite of the present invention includes any one or more of the above referenced embodiments of the first aspect of the present invention wherein said plurality of natural or synthetic melanin nanoparticles have a diameter of from about 10 nm to about 500 nm. In one or more embodiments, the photothermal-responsive melanin-based nanocomposite of the present invention includes any one or more of the above referenced embodiments of the first aspect of the present invention wherein the concentration of said plurality of natural or synthetic melanin nanoparticles in the polymer matrix is from about 0.10% to about 40 wt. %. In one or more embodiments, the photothermal-responsive melanin-based nanocomposite of the present invention includes any one or more of the above referenced embodiments of the first aspect of the present invention wherein said plurality of natural or synthetic melanin nanoparticles are substantially homogeneously distributed throughout the polymer matrix.

In a second aspect, the present invention is directed to an ink, paint, or coating comprising the photothermal-responsive melanin-based nanocomposite described above wherein the temperature of the ink, paint, or coating increases when it is exposed to light. In one or more of these embodiments, the polymer matrix is an ink vehicle or binder or a paint vehicle or binder. In some of these embodiments, the polymer matrix is selected from the group consisting of transparent varnish (alkyds), polyethylene glycols, acrylics, polyurethanes, cellulosics, epoxies, and combinations thereof. In some embodiments, the polymer matrix is a clear varnish.

In one or more embodiments, the ink, paint, or coating of the present invention includes any one or more of the above referenced embodiments of the second aspect of the present invention wherein the said plurality of natural or synthetic melanin nanoparticles comprises polydopamine (PDA) nanoparticles. In various embodiments, the ink, paint, or coating of the present invention includes any one or more of the above referenced embodiments of the second aspect of the present invention wherein the concentration of the plurality of natural or synthetic melanin nanoparticles in the polymer matrix is from about 0.10% to about 40 wt. %.

In a third aspect, the present invention is directed to a written message, comprising symbols and/or letters, or a design formed using one or more of the photothermal-responsive melanin-based nanocomposites described above wherein said written message or design are visible using an infrared camera when the written message is exposed to light. In one or more embodiments, the one or more photothermal-responsive melanin-based nanocomposites are one or more of the inks, paints, or coatings described above.

In one or more embodiments, the written message or design of the present invention includes any one or more of the above referenced embodiments of the third aspect of the present invention comprising two or more of the photothermal-responsive melanin-based nanocomposites described above, each of said two or more photothermal-responsive melanin-based nanocomposite having a different melanin nanoparticle concentration. In one or more of these embodiments, the written message or design comprises a first photothermal-responsive melanin-based nanocomposite having a first melanin nanoparticle concentration and a second photothermal-responsive melanin-based nanocomposite having a second and higher melanin nanoparticle concentration.

In one or more embodiments, the written message or design of the present invention includes any one or more of the above referenced embodiments of the third aspect of the present invention wherein the difference between said first melanin nanoparticle concentration and said second and higher melanin nanoparticle concentration is from about 0.25 wt. % and about 10 wt. %.

In a fourth aspect, the present invention is directed to a sensor comprising photothermal-responsive melanin-based nanocomposite set forth above.

In a fifth aspect, the present invention is directed to a method for confirming the authenticity of a product using the photothermal-responsive melanin-based nanocomposites described above comprising: preparing a photothermal-responsive melanin-based nanocomposite by distributing a plurality of natural or synthetic melanin nanoparticles throughout a polymer matrix; applying the photothermal-responsive melanin-based nanocomposite to a pre-determined area on authentic products and allowing it to dry or harden; obtaining a product that may or may not be authentic; exposing an area of the product that includes at least a portion of the predetermined area to which the photothermal-responsive melanin-based nanocomposite has been applied and a comparable portion of the product outside said predetermined area to a light source; and measuring the temperature of the product where it was exposed to the light to determine if the temperature of the product is higher in the predetermined areas to which the photothermal-responsive melanin-based nanocomposite was applied than in comparable area of the product outside said predetermined area; wherein the authenticity of the product may be confirmed if the measured temperature of the product is higher in the predetermined areas to which the photothermal-responsive melanin-based nanocomposite was applied than in comparable areas of the product outside said predetermined area.

In one or more embodiments, the method of the present invention includes any one or more of the above referenced embodiments of the fifth aspect of the present invention wherein the concentration of the plurality of natural or synthetic melanin nanoparticles in the photothermal-responsive melanin-based nanocomposite is from about 0.10% to about 40 wt. %.

In one or more embodiments, the method of the present invention includes any one or more of the above referenced embodiments of the fifth aspect of the present invention wherein the step of applying comprises applying the written message, comprising symbols and/or letters, or design to the pre-determined area.

In some embodiments, the presence of the photothermal-responsive melanin-based nanocomposite on the authentic product is not visible. In one or more embodiments, the method of the present invention includes any one or more of the above referenced embodiments of the fifth aspect of the present invention wherein the areas of the product to which the photothermal-responsive melanin-based nanocomposite have been applied and comparable area to which the photothermal-responsive melanin-based nanocomposite have not been applied are visually indistinguishable.

In one or more embodiments, the method of the present invention includes any one or more of the above referenced embodiments of the fifth aspect of the present invention wherein the step of measuring the temperature is performed using a thermal imaging camera. In one or more of these, the thermal imaging camera is a forward looking infra-red (FLIR) thermal camera. In one or more embodiments, the method of the present invention includes any one or more of the above referenced embodiments of the fifth aspect of the present invention wherein the light source produces light having wavelengths from about 290 nm to about 1200 nm. In one or more embodiments, the light source is a broadband solar lamp or an infrared (IR) solar lamp.

### BRIEF DESCRIPTION OF THE DRAWINGS

For a more complete understanding of the features and advantages of the present invention, reference is now made to the detailed description of the invention along with the accompanying figures in which:

FIGS. 1A-B are images showing sheets of white paper with paint brush strokes using different dispersions of various concentration of PDA in a transparent varnish (FIG. 1A) and images of the sheets of white paper shown in FIG. 1A heated by an IR lamp taken using an thermal imaging camera after a short period of time (15 seconds), in which the strokes are distinguishable from each other with higher temperatures achieved at higher PDA concentrations (FIG. 1B); and

FIGS. 2A-B are images showing the results of hidden pattern experiments where FIG. 2A is an image showing a white piece of paper covered with a low concentration of a PDA nanoparticles (1 wt. %) in a transparent varnish binder upon which the word “UAKRON” has been written using a high concentration of PDA nanoparticles (20 wt. %) in a transparent varnish binder and a thermographic snapshot of the paper shown in FIG. 2A when heated by an IR lamp using a thermal camera to detect the hidden pattern (FIG. 2B).

FIG. 3A is a schematic showing a 3D printed mold being filled with epoxy containing a high concentration of PDA (5 wt. %), which is then cured and embedded into an epoxy matrix doped with lower concentration of PDA (1 wt. %).

FIG. 3B is a series of images which show, starting from left, a visual image of a pattern-embedded disc followed by series of thermographic snapshots of the disc upon exposure to solar IR lamp radiation captured at varying temperature points.

FIGS. 4A-B are images of highly concentrated PDA-filled (5 wt. %) nanocomposite designs (FIG. 4A) and thermographic snapshots of the pattern-embedded discs shown in FIG. 4A after being heated by the solar IR lamp (FIG. 4B);

FIG. 5 shows images taken of epoxy-PDA nanocomposites comparing of the pure epoxy resin (far left) and epoxy-PDA nanocomposites having different concentrations at (1 wt. %, 5 wt. %, 10 wt. %, and 20 wt. %) of PDA nanoparticles dispersed in epoxy resin;

FIGS. 6A-B are scanning electron micrographs (SEM) of synthesized polydopamine (PDA) nanoparticles (Scale bars are 1 μm);

FIGS. 7A-D are cross-section SEM images of a photothermal-responsive PDA/epoxy nanocomposites with different concentrations of PDA nanoparticles homogeneously dispersed in the epoxy resin wherein FIG. 7A, FIG. 7B, FIG. 7C, and FIG. 7D represent 1, 5, 10, and 20 wt. % PDA-loaded nanocomposites, respectively (Scale bars are 1 μm);

FIG. 8 is a schematic of the solar IR lamp set-up for irradiating the melanized samples wherein the lamp is mounted at 50 cm from the sample to achieve an intensity of 1000 W/m², and the forward looking infra-red (FLIR) thermal camera is mounted at a distance of 70 cm;

FIGS. 9A-B are graphs showing solar radiation spectrum received by the earth's surface (FIG. 9A) and a commercial IR lamp profile (FIG. 9B);

FIG. 10 is a graph showing the heating and cooling curves of the samples during the 10 min irradiation ON/OFF cycles (solid lines) with the shaded region representing the standard deviations;

FIGS. 11A-B relate to finite-difference time-domain (FDTD) modeling to calculate absorption as a function of PDA-loading where FIG. 11A is a comparison computer-aided design (CAD) schematics presenting the morphology of the nanocomposites used in the calculation of optical absorption of the PDA/epoxy nanocomposites with varying concentrations (by wt. %) of PDA that were used in the absorption calculations and FIG. 11B is a plot showing absorption as a function of wavelength (nm) for various types of epoxy nanocomposites wherein the spectra represent the average of the absorption curves obtained using both p- and s-polarization states of incident light;

FIGS. 12A-B relate to thermal conductivity and radiation by emission where FIG. 12A is a schematic diagram of a custom-built thermal conductivity apparatus and FIG. 12B is a graph showing heat transfer results of epoxy-PDA nanocomposites for thermal conductivity (in black) and emissivity (in red) as a function of PDA loading;

FIG. 13 relates to emissivity calculation for epoxy resin and epoxy-PDA nanocomposites showing (on top) images of the samples with the attached insulating tape as a reference and (bottom) thermal images of the same samples with the respective boxes (Bx), enclosing a small portion of the sample and taped area;

The patent or application file contains at least one drawing executed in color. Copies of this patent or patent application publication with color drawing(s) will be provided by the Office upon request and payment of the necessary fee.

### DETAILED DESCRIPTION OF THE ILLUSTRATIVE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

As set forth above, one or more embodiments of the present invention provide a photothermal-responsive melanin-based nanocomposite comprising a plurality of natural or synthetic melanin nanoparticles dispersed in a polymer matrix. In various embodiments, the photothermal-responsive melanin-based nanocomposite is believed to be suitable for use in anti-counterfeiting, photothermal responsive-communication, sensors, and heat management, and other applications. Because, as set forth above, melanin and its synthetic mimics are known to exhibit photothermal absorption behavior and will differentially heat when exposed to light, synthetic melanin nanoparticles (like PDA) can be easily loaded in many polymeric materials (like polystyrene, acrylates, epoxies, polyurethanes, poly(lactic acid), polyolefins, polysiloxanes (PDMS), rubbers and elastomers) using common and benign solvents for the polymeric matrix and for PDA dispersion where necessary, to fabricate the substantially homogeneously filled polymeric nanocomposite materials. Advantageously and unlike metals, lanthanides, or other toxic fillers for polymeric materials, use of synthetic melanin nanoparticles as fillers does not render these nanocomposites toxic or otherwise harmful to humans and environment. In various embodiments, the thermal radiative properties of the nanocomposite may easily be controlled by tuning the concentration of the melanin or synthetic melanin (e.g., PDA) nanoparticles dispersed into the polymeric matrix.

Similarly, the easy dispersibility of natural or synthetic melanin nanoparticles during filler loading and the malleability/compliance of the PDA-loaded polymeric matrix allows for numerous intricate patterns and designs to be fabricated and broadband absorption of natural and synthetic melanin across the UV-visible region of the electromagnetic spectrum allows for the generation of very dark nanocomposites which are unidentifiable to the naked eye even at varying concentration loadings. And since synthetic melanin nanoparticles are very easy to disperse into polymers, in some embodiments of the present invention, they can readily be loaded into polymer melts and mixed via the shearing processes (extrusion, brabenders, two-roll mills, rubber mills). In some other embodiments, the synthetic melanin nanoparticles can be dispersed into paint vehicles to yield recipes for ink and paint formulations that are photothermally responsive. This characteristic facilitates fabrication of embedded patterns invisible to the naked eye facilitating the use of these photothermal-responsive melanin-based nanocomposites in anti-counterfeiting, thermal communications, sensors, or other applications where something needs to be concealed from the naked eye, but nevertheless be present. In one or more embodiments, differential photothermally-absorbed regions can be achieved using different loading concentrations of PDA in a single area (high loading concentration for the embedded design and low for the surrounding) yielding a significant temperature difference between the two upon exposure to solar IR lamp radiation. A thermal camera can be used to show this difference, making the hidden pattern visual.

The following terms may have meanings ascribed to them below, unless specified otherwise. As used herein, the terms “comprising” “to comprise” and the like do not exclude the presence of further elements or steps in addition to those listed in a claim. Similarly, the terms “a,” “an” or “the” before an element or feature does not exclude the presence of a plurality of these elements or features, unless the context clearly dictates otherwise. Further, the term “means” used many times in a claim does not exclude the possibility that two or more of these means are actuated through a single element or component.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term “about.”

It should be also understood that the ranges provided herein are a shorthand for all of the values within the range and, further, that the individual range values presented herein can be combined to form additional non-disclosed ranges. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Further, as used herein, the term refers to a widespread biological pigment found in various taxa and exhibits unique properties including a high RI, broadband absorption from UV to visible to infrared, radical quenching ability, and metal ion chelation ability. Melanin can be categorized into different classes: eumelanin, pheomelanin, and allomelanin, depending upon the monomer and the enzymes involved in its synthesis process. As used herein, the term “natural melanin” is used to refer to eumelanin, allomelanin or pheomelanin extracted from natural sources. Similarly, synthetic melanin is used herein to refer to a class of synthetic compounds, like polydopamine (PDA), that mimic some or all of the properties of natural melanin. Unless it is otherwise stated or is clear from the context, the term “melanin nanoparticles” is used to refer to either one or both of natural and synthetic melanin nanoparticles.

As used here, the term “photothermal-responsive” is used to refers to a material having thermal properties that respond to exposure to light. Further, a first material will be understood to be “homogeneously distributed” within a second material where the concentration of the first material is essentially the same at any location within the second material. Similarly, a first material will be understood to be “substantially homogeneously distributed” within a second material where the concentration of the first material is nearly the same (within 0.25 wt. %) at any location within the second material.

All publications, patent applications, patents, and other references mentioned herein are expressly incorporated by reference in their entirety, which means that they should be read and considered by the reader as part of this text. That the document, reference, patent application, or patent cited in this text is not repeated in this text is merely for reasons of conciseness. In the case of conflict, the present disclosure, including definitions, will control. All technical and scientific terms used herein have the same meaning.

Further, any compositions or methods provided herein can be combined with one or more of any of the other compositions and methods provided herein. The fact that given features, elements or components are cited in different dependent claims does not exclude that at least some of these features, elements or components maybe used in combination together.

In a first aspect, the present invention is directed to a photothermal-responsive melanin-based nanocomposite comprising a plurality of natural or synthetic melanin nanoparticles dispersed throughout a polymer matrix wherein the temperature of the nanocomposites increases when it is exposed to light. As set forth above, the thermal radiative properties of the nanocomposite may easily be controlled by tuning the concentration of the melanin or synthetic melanin (e.g., PDA) nanoparticles dispersed into the polymeric matrix.

Melanin is a widespread biological pigment found in various taxa and exhibits unique properties including a high RI, broadband absorption from UV to visible to infrared, radical quenching ability, and metal ion chelation ability. Melanin can be categorized into different classes: eumelanin, pheomelanin, and allomelanin, depending upon the monomer and the enzymes involved in its synthesis process. In various embodiments, the melanin nanoparticles used to form the photothermal-responsive melanin-based nanocomposites of the present invention may be natural or synthetic.

In one or more embodiments, the natural or synthetic melanin nanoparticles will comprise a natural melanin and may come from any suitable source, including, but not limited to bacteria, fungi, plants, or animals. Suitable sources of natural melanin include, without limitation, cuttlefish (Sepia officinalis) inks, black fish crow feathers (Corvus ossifragus), wild turkey feathers (Melleagris gallopavo), black human hair, black garlic, various fungi (Cryptococcus neoformans, Aspergillus fumigatus, Apiosporina morbosa and Colletotrichum lagenarium) and bacteria. In one or more embodiment, the natural melanin may be extracted from the Black Knot fungus (Apiosporina morbosa) that infects the woody parts of plum, cherry, apricot, and chokecherry trees.

In one or more embodiments, the natural or synthetic melanin nanoparticles will comprise a synthetic melanin. Synthetically, melanin can be prepared in the lab by polymerizing various monomeric precursors such as dopamine, L-3,4-dihydroxyphenylalanine (L-DOPA), catechol, 5,6-dihydroxyindole (DHI), leucodopachrome, tryptamine, serotonin, 5,6-dihydroxyindole-2-carboxylic acid (DHICA), epinephrine, norepinephrine, tyrosine, adrenochrome, and 1,8-dihyroxynapthalene (DHN), as listed below. In some other embodiments, the synthetic melanin may be prepared from polymerization of cysteine, selenocysteine, 5-cys-DOPA, 2,5-dihydroxyphenylacetic acid or homogentisic acid (HGA). Some of the various chemical structures of the different monomers that can be utilized to create synthetic melanin are shown below.

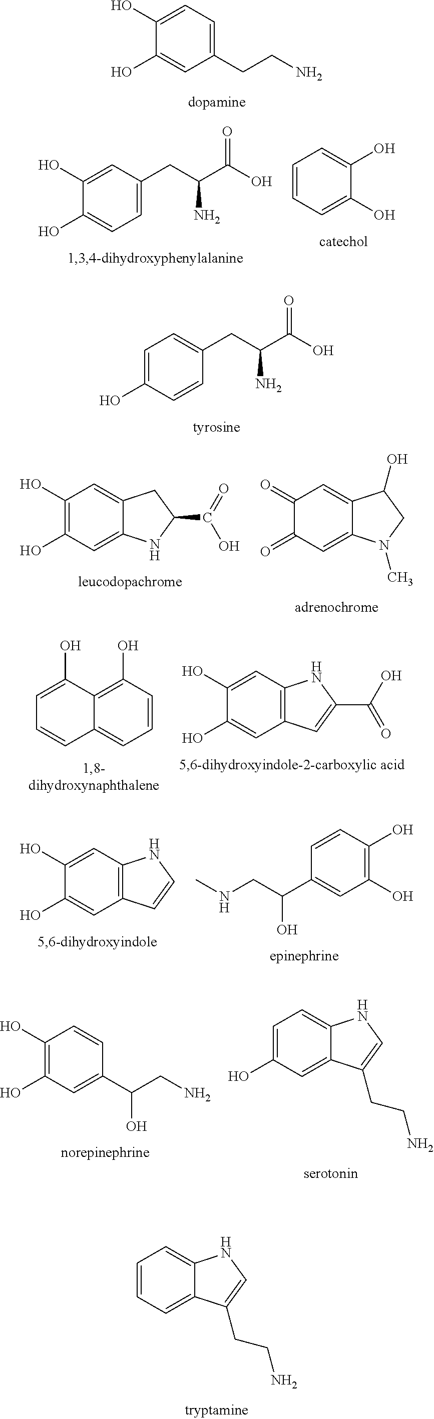

In various embodiments, the polymerization can be catalyzed using enzymes, various bases (Tris buffer, sodium hydroxide (NaOH), sodium bicarbonate buffer (NaHCO₃/Na₂CO₃), phosphate buffer, ammonia, Bicine buffer) and other chemical oxidants (such as sodium periodate, ammonium per(oxodi)sulfate, potassium permanganate, copper sulfate, and Fe (III)). Melanin has been synthesized both in the form of particles and in the form of coating using these various precursors. But a significantly large amount of work has been done specifically on polydopamine (PDA) coating since Lee et al. published the article on PDA coating in Science in 2007. (See, Lee, H., Dellatore, S. M., Miller, W. M. and Messersmith, P. B., 2007. Mussel-inspired surface chemistry for multifunctional coatings. Science, 318(5849), pp. 426-430, the disclosure of which is incorporated herein by reference in its entirety).

In one or more embodiments, the natural or synthetic melanin nanoparticles will comprise a synthetic melanin used to form the photothermal-responsive melanin-based nanocomposites of the present invention comprises polydopamine (PDA). As is known in the art, PDA may be synthesized from a dopamine monomer using the mechanism shown in Scheme 1 below.

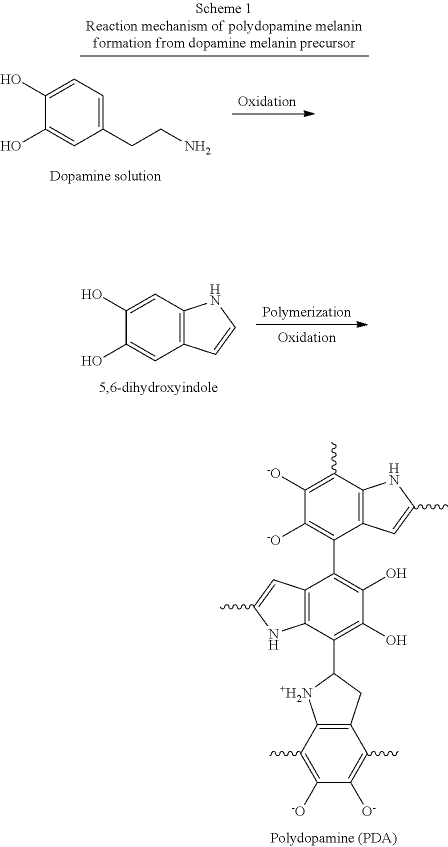

In some embodiments, synthetic melanin nanoparticles may be formed by oxidative polymerization of dopamine molecules (Sigma-Aldrich) in a base environment following the procedure described in M. Xiao, Y. Li, M. C. Allen, D. D. Deheyn, X. Yue, J. Zhao, N. C. Gianneschi, M. D. Shawkey, A. Dhinojwala, “Bio-inspired structural colors produced via self-assembly of synthetic melanin nanoparticles.” ACS Nano 9, 5454-5460 (2015), the disclosure of which is incorporated herein by reference in its entirety.

In various embodiments, the natural or synthetic melanin nanoparticles used to create the photothermal-responsive melanin-based nanocomposite of the present invention will have a diameter of from about 10 nm to about 500 nm. In some embodiments, the natural or synthetic melanin nanoparticles used to create the photothermal-responsive melanin-based nanocomposite of the present invention will have a diameter of from about 50 nm to about 500 nm, in other embodiments, from about 100 nm to about 500 nm, in other embodiments, from about 150 nm to about 500 mu, in other embodiments, from about 200 nm to about 500 nm, in other embodiments, from about 200 nm to about 500 nm, in other embodiments, from about 250 nm to about 500 nm, in other embodiments, from about 300 nm to about 500 nm, in other embodiments, from about 350 nm to about 500 nm, in other embodiments, from about 400 nm to about 500 nm, in other embodiments, from about 100 nm to about 450 nm, in other embodiments, from about 100 nm to about 400 nm, in other embodiments, from about 100 nm to about 350 nm, in other embodiments, from about 100 nm to about 300 nm, in other embodiments, from about 100 nm to about 250 nm, and in other embodiments, from about 100 nm to about 200 nm.

The polymer matrix in which the natural or synthetic melanin nanoparticles are dispersed serves primarily to hold the melanin nanoparticles in place and is not particularly limited, provided that the material used does not prevent light from reaching the melanin nanoparticles, exhibit photothermal absorption behavior that interferes with that of the melanin nanoparticles, or contain any substance that does either one, such as other light absorbing pigments like carbon black. Suitable materials for the polymer matrix may include, without limitation, epoxies, polystyrene, acrylates, polyurethanes, poly(lactic acid), polyolefins, vinyls (polyvinyl alcohol), polysiloxanes (PDMS), rubbers and elastomers, chitosan, cellulose acetates, silk, polysaccharides, cellulose-based matrices, carbohydrates, wool, or a combination thereof. In some embodiments, the polymer matrix may be an ink vehicle or binder or a paint vehicle or binder.

In various embodiments, the concentration of melanin nanoparticles in the polymer matrix will be from about 0.1 wt. % to about 40 wt. %. In some embodiments, the concentration of melanin nanoparticles in the polymer matrix will be from about 0.25 wt. % to about 40 wt. %, in other embodiments, from about 0.5 wt. % to about 40 wt. %, in other embodiments, from about 1 wt. % to about 40 wt. %, in other embodiments, from about 3 wt. % to about 40 wt. %, in other embodiments, from about 5 wt. % to about 40 wt. %, in other embodiments, from about 10 wt. % to about 40 wt. %, in other embodiments, from about 20 wt. % to about 40 wt. %, in other embodiments, from about 0.25 wt % to about 30 wt. %, in other embodiments, from about 0.25 wt. % to about 20 wt. %, in other embodiments, from about 0.25 wt. % to about 15 wt. %, in other embodiments, from about 0.25 wt. % to about 10 wt. %, and in other embodiments, from about 0.25 wt. % to about 5 wt. %. In some embodiments, the concentration of melanin nanoparticles in the polymer matrix will be from about 0.5 wt. % to about 20 wt. %. In some embodiments, the photothermal-responsive melanin-based nanocomposite may be formed two or more polymer matrixes each having a different concentration of melanin nanoparticles.

As set forth above, the thermal radiative properties (i.e., heat produced) of the photothermal-responsive melanin-based nanocomposite increases as a function of the concentration of melanin nanoparticles. In various embodiments, the thermal radiative properties of the nanocomposite may easily be controlled by tuning the concentration of the melanin or synthetic melanin (e.g., PDA) nanoparticles dispersed into the polymeric matrix.

In various embodiments, the photothermal-responsive melanin-based nanocomposite of the present invention may also comprise one or more additives, such as pigments, crosslinking agents, plasticizers, antioxidants, and/or fillers of the types commonly used in the various polymers and polymer applications. The use of additives is not particularly limited provided that the additives are not strongly light absorbing, like carbon black. While it is preferable that the polymer matrix does not contain any additives that affect the ability of the light to reach the melanin nanoparticles, the invention is not to be so limited and some degree of light absorption and/or scattering may occur and is within the scope of the present invention provided that light still reaches the melanin nanoparticles in sufficient quantities to cause the temperature of the nanocomposite to increase, as described above.

In one or more embodiments, to avoid problems of filler aggregation and localized heat accumulation the melanin nanoparticles are preferably substantially homogeneously distributed throughout the polymer matrix. In various embodiments, the melanin nanoparticles may be distributed throughout the polymer matrix by any suitable method known in the art for that purpose. In some embodiments, the melanin nanoparticles can readily be loaded into polymer melts and mixed via the shearing processes (extrusion, brabenders, two-roll mills, rubber mills). As set forth below, a substantially homogeneous distribution of the melanin nanoparticles throughout the polymer matrix may be facilitated using a common solvent for polymer (as well as any crosslinking agents, hardeners, or other additives present in or to be added to the polymer) and the suspension containing the melanin nanoparticles. Suitable solvents of this purpose will, of course, depend upon the polymer to be used. In these embodiments, the solvents may be removed by evaporation and/or vacuum extraction.

In second aspect, the present invention is directed to an ink, paint, or coating comprising the photothermal-responsive melanin-based nanocomposite discussed above. In these embodiments, the melanin nanoparticles are as set forth above, but the polymer matrix may be an ink vehicle or binder or a paint vehicle or binder. As with the photothermal-responsive melanin-based nanocomposite discussed above, these inks, paints and/or coatings exhibit photothermal absorption behavior and will differentially heat when exposed to light. In one or more embodiments, the natural or synthetic melanin nanoparticles comprise polydopamine (PDA) nanoparticles. Suitable materials for the polymer matrix in these embodiments may include, without limitation, transparent varnish (alkyds), polyethylene glycols, acrylics, polyurethanes, cellulosics, epoxies, polyesters, polyacrylates, and combinations thereof. In some embodiments, the polymer matrix is a clear varnish.

In one or more embodiments, the concentration of the plurality of natural or synthetic melanin nanoparticles in the polymer matrix is from about 0.25 wt. % to about 40 wt. %. as set forth above. In some embodiments, the concentration of melanin nanoparticles in the polymer matrix will be from about 0.5 wt. % to about 20 wt. %.

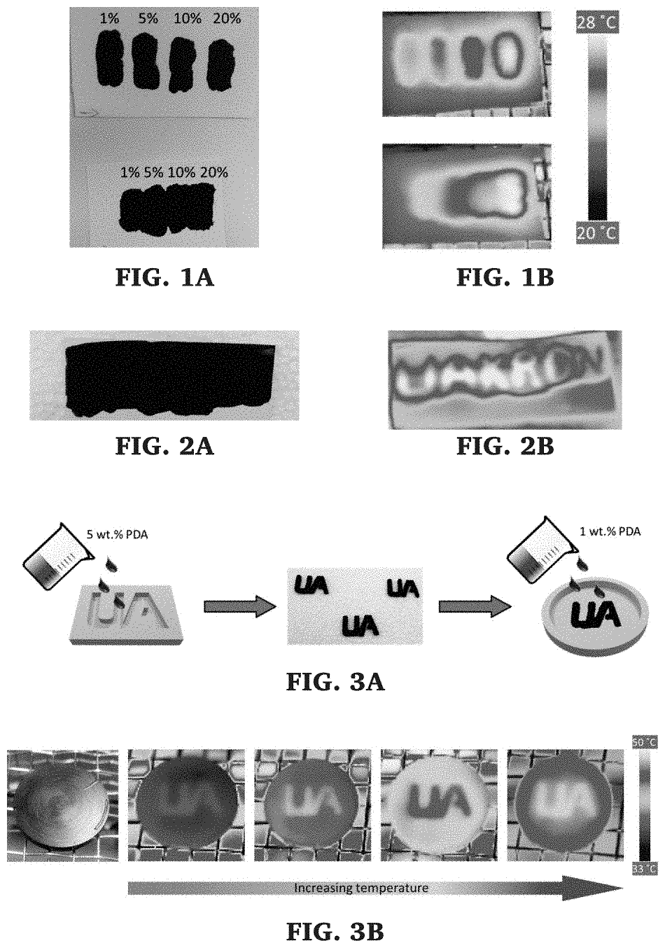

In some embodiments, the photothermal-responsive melanin-based nanocomposite may be formed two or more inks, paints, or coatings each having a different concentration of melanin nanoparticles as shown in FIGS. 1A-B and 2A-B.

In various embodiments, the ink, paint, or coating may also include pigments, and other additives generally associated with inks, paints, or coatings provided that they do not prevent light from reaching the melanin nanoparticles. For example, additives, like carbon black, which are strongly light absorbing should be avoided. While it is preferable that the ink, paint, or coating not contain any additives that affect the ability of the light to reach the melanin nianoparticles, the invention is not to be so limited and some degree of light absorption and/or scattering may occur and is within the scope of the present invention provided that sufficient light still reaches the melanin rianoparticles in sufficient quantities to cause the temperature of the ink, paint, or coating to increase, as described above.

In a third aspect, the present invention is directed to a written message comprising symbols or letters, or a design, for use in anti-counterfeiting and/or thermal communication applications. In these embodiments, a message or design is formed on a product or other object which will be visible only when viewed using an infra-red camara. As will be apparent, the written message or design in these embodiments is intended to be hidden to the degree possible and is preferably completely invisible to the naked eye, particularly against a dark background. The melanin nanoparticles are visibly dark in color, and at concentrations as low as 0.1 wt. %, will start to darken the polymer matrix against white background. Accordingly, in these embodiments, the message or design is preferably placed on an area of the product or other object already having a dark color as it will make it more difficult to see or notice. Against a dark background, the written message or design in one or more of these embodiments are essentially indistinguishable from the background and completely invisible to the naked eye.

In some embodiments, the written message or design will be formed from one or more of the photothermal-responsive melanin-based nanocomposites discussed above. In some of these embodiments, written message or design will be formed from two or more of the photothermal-responsive melanin-based nanocomposites discussed above, each one having a different concentration of melanin particles. (See, e.g., FIGS. 3A-B) In some embodiments, the two or more of the photothermal-resporisive melanin-based nanocomposites forming the written message or design will be formed using the same polymer matrix, but that need not be the case. In some embodiments, the two or more of the photothermal-responsive melanin-based nanocomposites forming the written message or design will be formed using the different polymer matrixes.

In some other embodiments, the written message or design will be formed from two or more of the ink, paint, or coating described above, each one having a different concentration of melanin nanoparticles. (See, e.g., FIGS. 2A-B) In some embodiments, the two or more inks, paints, or coatings forming the written message or design will be formed using the same polymer matrix, but that need not be the case. In some embodiments, the two or more of the inks, paints, or coatings forming the written message or design will be formed using the different polymer matrixes. Likewise, the two or more inks, paints, or coatings forming the written message or design will preferably contain the same pigments and other additives, if any, so as to display the same color when viewed by the naked eye.

In fact, because the thermal properties of the substrate are likely unknown and/or variable, it has been found to be preferable to use two or more concentrations of melanin nanoparticles, so that the contrast in temperatures of the two will be more consistent and easier to recognize in the thermal image and the written message or design easier to see. In some embodiments, one or more nanocomposites having a higher concentration of melanin nanoparticles may be inlaid within a form comprising a nanocomposite having a higher concentration of melanin nanoparticles, as shown in FIGS. 2A-B, 3A-B. The specific methods for forming the written message or design having two or more melanin nanoparticle concentrations are not particularly limited. It is preferred, however, that polymers matrixes having different melanin nanoparticle concentrations not be allowed to mix in their liquid forms.

As set forth above, in one or more embodiments, the message or design will comprise a photothermal-responsive melanin-based nanocomposite formed from a polymer matrix having a relatively low melanin nanoparticle concentration and one or more photothermal-responsive melanin-based nanocomposite formed from a polymer matrix having a relatively high melanin nanoparticle concentration. As will be apparent, it is the difference in melanin narioparticle concentrations, more than the specific melanin nanoparticle concentrations, that is important in forming written message or design. The difference does not need to be large to provide the temperature differences necessary for the message or design to be visible when illuminated using a thermal imaging camera but is preferably at least 0.1 wt. %. In one or more of these embodiments, the thermal imaging camera will be a forward looking infra-red (FLIR) thermal camera. In various embodiments, the difference in melanin nanoparticle concentrations between the two photothermal-responsive melanin-based nanocomposites forming the written message or design will be from about 1 wt. % to about 5 wt. %, in other embodiments, from about 1 wt. % to about 10 wt. %, in other embodiments, from about 1 wt. % to about 20 wt. %, in other embodiments, from about 1 wt. % to about 30 wt. %, in other embodiments, from about 1 wt. % to about 40 wt. %, in other embodiments, from about 0.1 wt. % to about 5 wt. %, in other embodiments, from about 0.1 wt. % to about 10 wt. %, in other embodiments, from about 0.1 wt. % to about 20 wt. %, and in other embodiments, from about 0.1 wt. % to about 30 wt. %. In some embodiments, the difference in melanin nanoparticle concentrations between the two photothermal-responsive melanin-based nanocomposites forming the written message or design will be from about 0.25 wt. % and 10 wt. %. In some embodiments, the difference in melanin nanoparticle concentrations between the two photothermal-responsive melanin-based nanocomposites forming the written message or design will be about 4 wt. %.

The specific melanin nanoparticle concentrations used for the polymer matrix having the relatively low melanin nanoparticle concentration and the one or more polymer matrixes having a relatively high melanin nanoparticle concentration will, of course, depend upon such things as the optical and thermal properties of the polymers used, and the degree of dispersion of melanin particles in polymeric matrices. In one or more embodiments, the melanin nanoparticle concentration of the polymer matrix used to form the photothermal-responsive melanin-based nanocomposite having the relatively low melanin nanoparticle concentration will be from about 0.1 wt. % to about 3 wt. %. In some embodiments, the melanin nanoparticle concentration of the polymer matrix used to form the photothermal-responsive melanin-based nanocomposite having the relatively low melanin nanoparticle concentration will be from about 0.1 wt. % to about 2.5 wt. %, in other embodiments, from about 0.1 wt. % to about 2.0 wt. %, in other embodiments, from about 0.1 wt. % to about 1.5 wt. %, in other embodiments, from about 0.1 wt. % to about 1.0 wt. %, in other embodiments, from about 0.5 wt. % to about 3 wt. %, in other embodiments, from about 1 wt. % to about 3 wt. %, in other embodiments, from about 1.5 wt. % to about 3 wt. %, and in other embodiments, from about 2 wt. % to about 3 wt. %. In some other embodiments, the melanin nanoparticle concentration of the polymer matrix used to form the photothermal-responsive melanin-based nanocomposite with the relatively low melanin nanoparticle concentration will be from about 2 wt. % to about 5 wt. %. In still other embodiments, the melanin nanoparticle concentration of the polymer matrix used to form the photothermal-responsive melanin-based nanocomposite with the relatively low melanin nanoparticle concentration will be about 1 wt. %.

In one or more embodiments, the melanin nanoparticle concentration of the one or more polymer matrixes used to form the photothermal-responsive melanin-based nanocomposite having the relatively high melanin nanoparticle concentration will be from about 5 wt. % to about 40 wt. %. In some embodiments, the melanin nanoparticle concentration of the polymer matrix used to form the photothermal-responsive melanin-based nanocomposite having the relatively high melanin nanoparticle concentration will be from about 5 wt. % to about 30 wt. %, in other embodiments, from about 5 wt. % to about 20 wt. %, in other embodiments, from about 5 wt. % to about 15 wt. %, in other embodiments, from about 5 wt. % to about 10 wt. %, in other embodiments, from about 10 wt. % to about 40 wt. %, in other embodiments, from about 15 wt. % to about 40 wt. %, in other embodiments, from about 20 wt. % to about 40 wt. %, and in other embodiments, from about 30 wt. % to about 40 wt. %. In some embodiments, the melanin nanoparticle concentration of the polymer matrix used to form the one or more photothermal-responsive melanin-based nanocomposite with a relatively high melanin nanoparticle concentration will be about 5 wt. %.

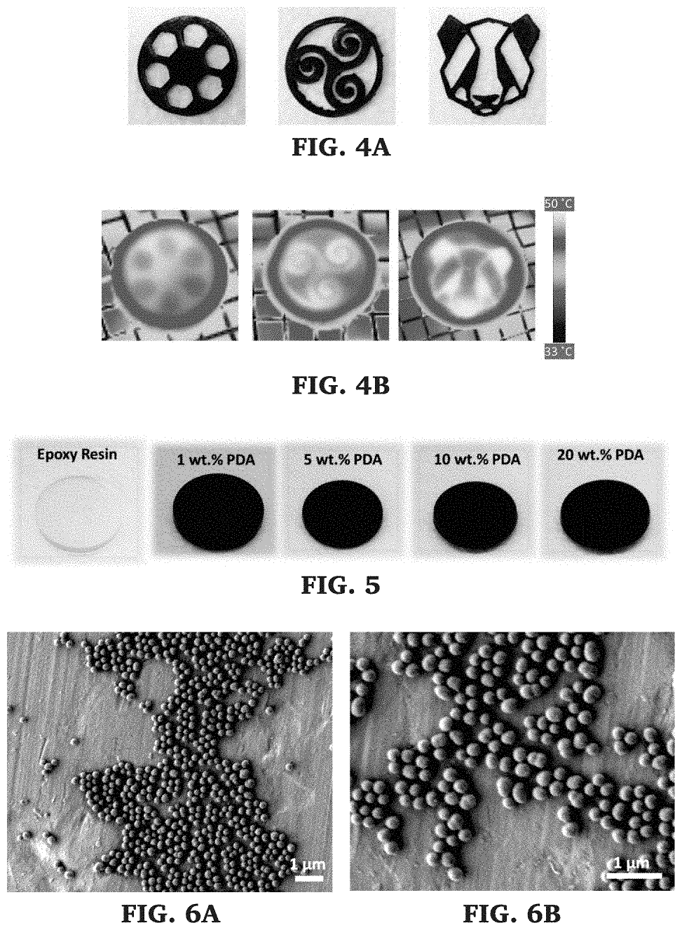

In the embodiments shown in FIGS. 3A, 4A, an inlay is first formed from a polymer matrix having a 5 wt. % melanin nanoparticle concentration using a mold. In these embodiments, once hardened the formed nanocomposite is then removed from the mold and placed in a second mold or container where a second polymer matrix, this one having a low (1 wt. %) melanin nanoparticle concentration, is added, filling all of the spaces around the message or design. In these embodiments, the second polymer matrix is then allowed to dry to form the written message or design of the present invention. In an alternative embodiment, the molded written message or design may be added to a mold or container after the second nanocomposite having a low (1 wt. %) melanin nanoparticle concentration has been added, but before it hardens, effectively inlaying the written message or design into the second nanocomposite having a low (1 wt. %) melanin nanoparticle concentration. This embodiment may be particularly well suited to designs having numerous internal openings that could be difficult to fill if the nanocomposite having the low (1 wt. %) melanin nanoparticle concentration is added to the design last.

In yet another alternative embodiment, the nanocomposite having a low (1 wt. %) melanin nanoparticle concentration may be formed first using a solid object having the shape of the message or design in the mold to create a space for the polymer matrix having a higher melanin nanoparticle concentration. Once the polymer matrix dries, it will form a nanocomposite having a low melanin nanoparticle concentration with openings in the shape of the message or design. The openings are then filled with a polymer matrix having a higher melanin nanoparticle concentration to form the completed written message or design.

In the embodiment shown in FIGS. 2A-B, a first polymer matrix comprising a transparent varnish (a common paint vehicle) and having a relatively low melanin nanoparticle concentration of about 1 wt. % is applied to a substrate and allowed to dry to form a first nanocomposite. A second polymer matrix comprising the transparent varnish (a common paint vehicle) with a relatively high melanin nanoparticle concentration of about 5 wt. % is formulated and used to write a message across the first nanocomposite, which dries to form a second nanocomposite. As can be seen in FIG. 2A the message cannot be seen with the naked eye since there is insufficient contrast between the two nanocomposites for the eye to see. When the substrate is illuminated, however, the message becomes easily visible. (See, FIG. 2B).

In all of these embodiments, the written message or design will be visible using an infrared camera when the written message is exposed to light. In some embodiments, the light source produces light will produce wavelengths of light in the range of from about 290 nm to about 1200 nm. In one or more embodiments, the light source is a broadband solar lamp or an infrared (IR) solar lamp.

In a fourth aspect, the present invention is directed to a sensor comprising photothermal-responsive melanin-based nanocomposite described above. In these embodiments, a pattern or design as described above sensitive to photothermal effects heating more than the surrounding regions when exposed to light and acts like a photo-responsive sensor.

In a fifth aspect, the present invention is directed to a method of making the photothermal-responsive melanin-based nanocomposite described above that avoids problems of filler aggregation and localized heat accumulation. In these embodiments, substantially homogeneously distribution of the melanin nanoparticles throughout the polymer matrix may be facilitated using a common solvent for polymer and melanin nanoparticles. In these embodiments, the melanin nanoparticles are first suspended in a cosolvent for the polymer matrix. The suspension containing the melanin nanoparticles is added to the polymer and the solvent removed before the polymer matrix can harden. While the solvent in which the melanin nanoparticles have been suspended is only present for a relatively short time, it nevertheless greatly aids in distribution of the melanin nanoparticles throughout the polymer matrix.

As will be apparent, the melanin nanoparticles can only be distributed throughout the polymer when it or one of its precursors are in a fluid state. If the polymer used to form the polymer matrix is to be prepare from a polymer melt, for example, the suspension containing the melanin nanoparticles may be added and the solvent removed before the polymer is sufficiently cooled to harden. For two-part polymer systems, like epoxy for example, an initial determination must be made whether it is possible to distribute the melanin nanoparticles through the polymer and remove the solvent before the polymer begins to harden. In situations where there is sufficient time, the resin and hardener may be combined, and the melanin nanoparticle suspension added at the same time. In these embodiments, the melanin nanoparticles are homogeneously distributed throughout the polymer by mixing and/or agitation, the solvent is removed, and the polymer allowed to crosslink and harden. In cases where there is insufficient time to distribute the melanin nanoparticles through the polymer and remove the solvent before the polymer begins to harden, the polymer resin is combined with the melanin nanoparticle suspension first. Once the melanin nanoparticles are homogeneously distributed throughout the resin by mixing and/or agitation and the solvent is removed, the hardener is added, and the combination mixed until the polymer begins to harden.

Suitable solvents for this purpose will, of course, depend upon the polymer to be used. One of ordinary skill in the art will be able to select a suitable solvent without undue experimentation. If the polymer matrix is a polystyrene, for example, suitable solvents may include toluene or THF and if the polymer matrix comprises polymethylmethacrylate (PMMA) suitable solvents may include toluene and/or chloroform.

In a sixth aspect, the present invention is directed to a method for confirming the authenticity of a product using the photothermal-responsive melanin-based nanocomposite described above. In various embodiments, the photothermal-responsive melanin-based nanocomposites of the present invention may be used in anti-counterfeiting applications as a means of confirming the authenticity of a product. In some embodiments, the photothermal-responsive melanin-based nanocomposites of the present invention are placed in pre-determined area of the product and are configured in a pre-determined shape or design. In these embodiments, photothermal-responsive melanin-based nanocomposites are configured and placed on the product that their presence in not apparent and is, preferably, not visible to the naked eye. In some embodiments, the photothermal-responsive melanin-based nanocomposites placed on the authentic products will be a in the form of a written message or design, as discussed above. To confirm authenticity of a product, the area of the product where the nanocomposite may be present is illuminated and then viewed with a thermal imaging camera. In some embodiments, the product will be illuminated using light having a wavelength of 290 nm to 1200 nm. In some embodiments, the light source is a broadband solar lamp. In some other embodiments, the light source is an infrared (IR) solar lamp. If the photothermal-responsive melanin-based nanocomposites can be seen with the thermal imaging camera, then the product will be known to be authentic.

In various embodiments, the method comprises: preparing a photothermal-responsive melanin-based nanocomposite as described above by distributing a plurality of natural or synthetic melanin nanoparticles throughout a polymer matrix; applying the photothermal-responsive melanin-based nanocomposite to a pre-determined area on authentic products and allowing it to dry or harden; obtaining a product that may or may not be authentic; exposing an area of the product that includes at least a portion of the predetermined area to which the photothermal-responsive melanin-based nanocomposite has been applied and a comparable portion of the product outside said predetermined area to a light source; and measuring the temperature of the product where it was exposed to the light to determine if the temperature of the product is higher in the predetermined areas to which the photothermal-responsive melanin-based nanocomposite was applied than in comparable area of the product outside said predetermined area. In these embodiments, the authenticity of the product will be confirmed if the measured temperature of the product is higher in the predetermined areas to which the photothermal-responsive melanin-based nanocomposite was applied than in comparable areas of the product outside said predetermined area. In embodiments where the photothermal-responsive melanin-based nanocomposites placed on the authentic products are in the form of a written message or design, as discussed above, and comprise nanocomposites having two or more different melanin nanoparticle concentrations, then detection of the presence of the written message or design by the thermal imaging camera is sufficient to confirm authenticity, without regard to the comparable areas of the product outside said predetermined area.

In yet another aspect, the present invention is directed to a method for thermal communication using the photothermal-responsive melanin-based nanocomposites described above. In various embodiments, the written messages (in the form of letters or symbols) and/or designs described above, can be used to transfer information from a sender to a receiver without the message being visible to third parties. In these methods, a sender prepares a message intended to communicate information to the receiver. In some embodiments, the message may be a written message comprising letter or symbols that the sender believes will be understood by the receiver. In some embodiments, the message may be a written message comprising letters or symbols that the sender believes will be understood by the receiver.

### EXPERIMENTAL

To evaluate and further reduce the present invention to practice, synthetic melanin/polymer nanocomposites were fabricated using PDA as the synthetic melanin and an epoxy resin as the polymer matrix and the tested. In various experiments, PDA-epoxy nanocomposites having a range of different PDA concentrations were fabricated and then evaluated to, among other things, quantify thermal conductivity and emissivity, better understand their photothermal absorption properties, assess their suitability for use in inks, paints, and other coatings, and evaluate them for advanced applications like anticounterfeiting and infrared communications

### 1. FABRICATION OF AND RADIATIVE HEATING EXPERIMENTS

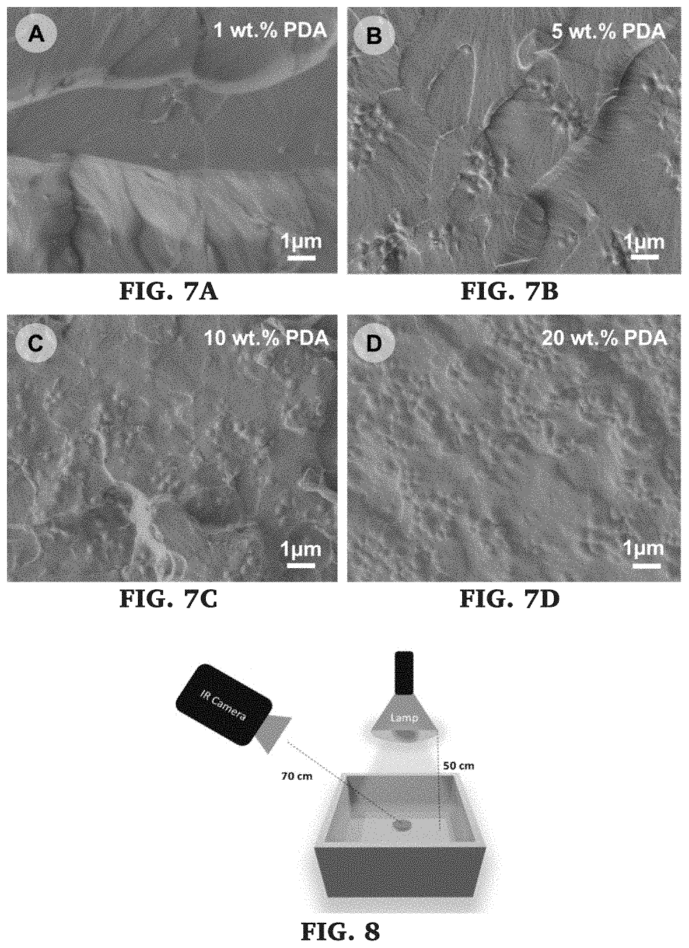

FIG. 5 illustrates the molded synthetic melanin (PDA) nanocomposite disc dimensions and the samples with varying PDA concentrations used for the radiative heating experiments. Epoxy resin is employed as the base polymeric matrix, in which different concentrations of PDA nanoparticles (particle morphology shown in FIGS. 6A-B) are well-dispersed, as can be observed in the scanning electron micrographs in FIGS. 7A-D. PDA is widely used as a coating material to help the dispersion of other solid materials in a wide variety of matrices, such us, oils, polymers, and aqueous environments. Uncrosslinked epoxy resin and PDA nanoparticles are both mechanically mixed using a co-solvent like isopropyl alcohol (IPA) to allow ready dispersibility of the particles to avoid agglomerations. The IPA is extracted using vacuum and the homogeneous uncrosslinked nanocomposite mixture is poured in polytetrafluoroethylene (PTFE) disc-shaped molds of 1 inch diameter and 2 mm depth. The nanocomposite molds are left for crosslinking at room temperature for 24 hours to obtain a hard nanocomposite. Three specimens of each concentration are fabricated to account for variations during experiments. It can be observed that, irrespective of the PDA doping concentration, all the discs look identically black. This behavior can be attributed to the photo-absorption property of PDA across UV-visible region of the electromagnetic spectrum.

The dispersion of PDA in the cured epoxy resin was analyzed using scanning electron microscopy (SEM). Liquid nitrogen was used to freeze the samples below their glass transition temperature (T_{g}), and then break them. This procedure ensured that the internal morphology of the nanocomposite was not disturbed. The developed protocol for fabricating PDA/polymer nanocomposites allows us to load varying quantities (small to large) of the biomaterial without signs of significant agglomeration in the base matrix, as shown in FIGS. 7A-D.

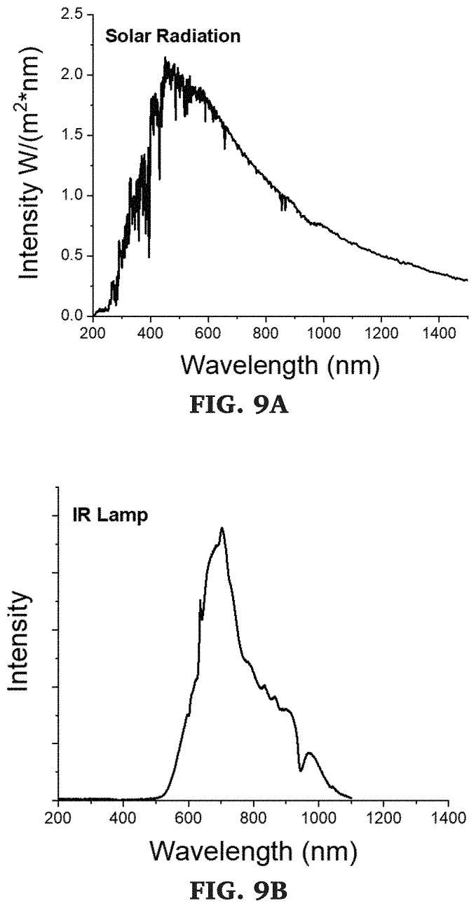

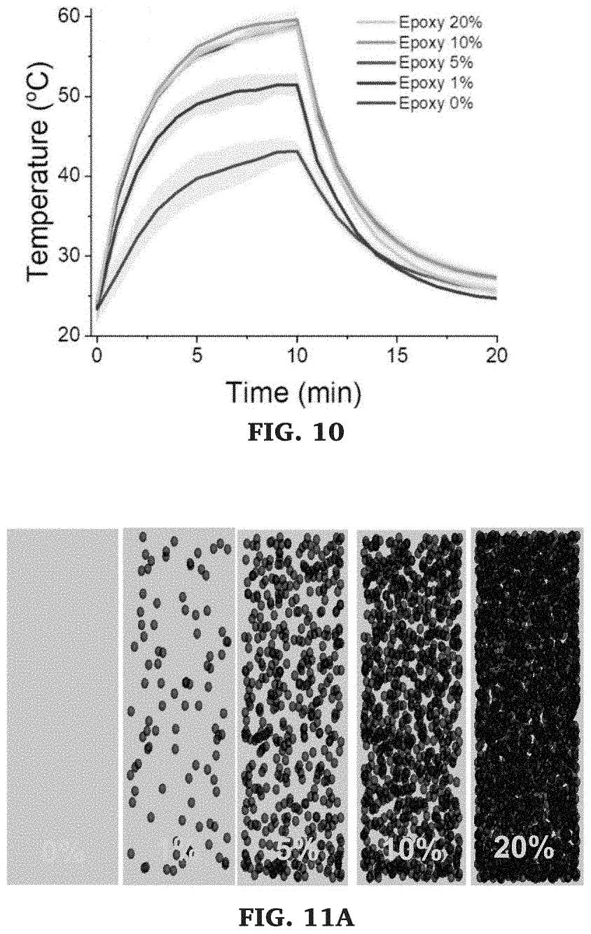

FIG. 8 shows the set up employed for measuring the surface temperature of each sample. A thermal lamp is used and set to provide a radiation intensity of 1000 W/m², which is similar to the energy reaching the earth's surface on a clear sunny day. FIG. 9A-B shows the spectra from the solar radiation and thermal lamp. Although there are some spectral differences, a thermal lamp was used to mimic the natural solar radiation. The samples are heated during the first 10 min, reaching its maximum temperature, then the lamp is shut off for another 10 min, allowing the samples to cool down. The temperature was recorded using a thermal camera every minute. FIG. 10 displays the increment in the surface temperature of each sample during the time that the lamp is on. Starting at room temperature, bare epoxy heats up along with the surroundings reaching a maximum temperature of 43° C. after the lamp is turned on for 10 min. However, even a small addition of PDA nanoparticles to the resin (1 wt. %), causes the sample to heat up more quickly and reach a max temperature of 51.5° C. Melanin is well-known for absorbing solar energy, especially as a surface coating material, where the increase in the PDA concentration is directly proportional to the surface temperature. It was found out that after adding 5 wt. % of PDA to the resin, a maximum surface temperature ˜60° C. was reached. Particularly, no significant rise in temperature was seen after a loading concentration of 5 wt. %. In these experiments, the highly loaded samples (10 wt. % and 20 wt. %) were found to reach practically the same maximum temperature for the same irradiation intensity. It is believed that the maximum temperature and the melanin nanoparticle concentration necessary to reach it, will depend upon a variety of factors including, without limitation, the thickness of the nanocomposite, the properties of the polymer matrix, and the intensity of the light. These results match well with what is observed in nature with melanized animals that utilize the energy from the sun to warm up their bodies.

### 2. OPTICAL ABSORPTION OF NANOCOMPOSITES BY FINITE-DIFFERENCE TIME-DOMAIN (FDTD)

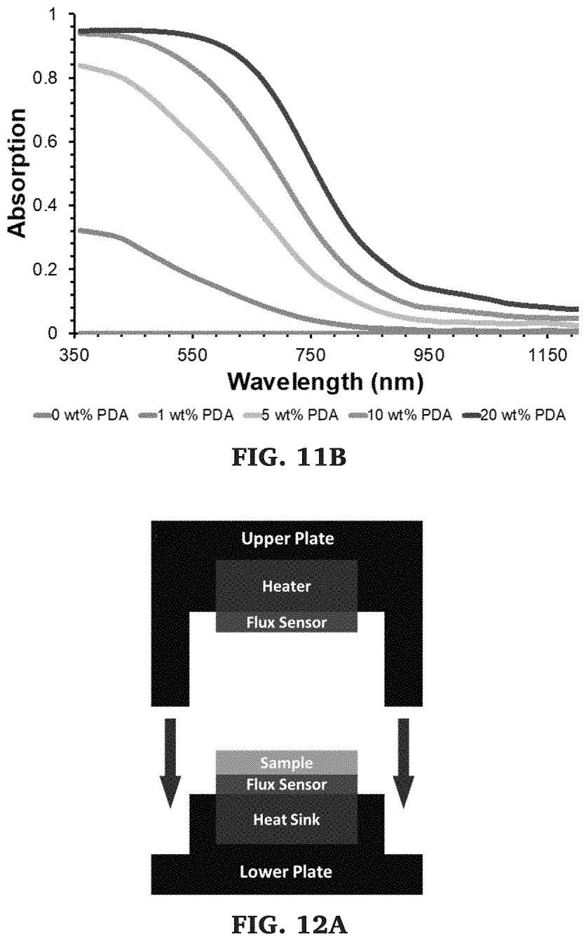

To understand how absorption scales in the nanocomposite systems with increasing synthetic melanin concentration (by wt. %), optical simulations were performed to calculate broadband absorption spectra using finite-difference time-domain (FDTD) calculations. FIG. 11A presents the morphology of the nanocomposites used in the calculation of optical absorption. FIG. 11B demonstrates that as the melanin concentration in the nanocomposite increases, the absorption capability of the system increases. This behavior is typical of an absorbing system and has been previously explained by other studies.

Now, these absorption spectra can be translated to obtain the cumulative amount of energy absorbed by the systems, which can reflect the steady-state temperature attained during photothermal heating. In other words, the temperature increase compared to the ambient temperature (20° C.) can be given by ΔT=q/h, where q is the cumulative energy absorbed at a light intensity of 1000 Wm⁻² and h is the convection coefficient (10 Wm⁻²K⁻¹). However, the system sizes are big compared to the barbule structures that were modeled in the previous study. In order to compensate for the size effects and to capture the complexities involved during light interaction with nanoparticle-filled composites, a fraction of the system size (10 μm thick) was simulated separately to obtain optical absorption profiles.

### 3. HEAT TRANSFER BY CONDUCTION AND EMISSION

Two other mechanisms of heat transfer where melanin could also affect the mechanisms by which thermal energy can be transferred between objects were also considered: conduction and emission.

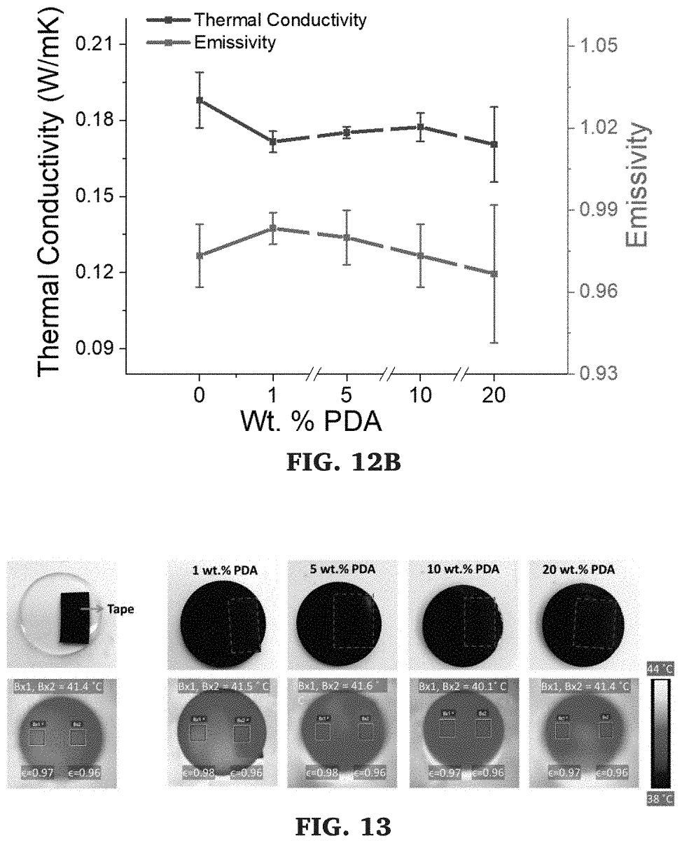

FIG. 12A shows the schematic of a custom-built heat flux meter used to measure the thermal conductivity of epoxy and epoxy-PDA composites. To avoid air gaps between the epoxy composite and the flux sensors that could impact the thermal conductivity values, the epoxy disc was placed among two Ecoflex™ OO-30 silicone rubber discs of the same dimensions and thickness. The soft material easily adapts to the contours of the sample and the flux sensors, giving full contact between them.

Equation 1 was employed to calculate the thermal conductivity (k) of materials and composites. The sample set thickness (L), heat flux (Q) and temperature difference across the sample (ΔT) were measured. Thermal conductivity of Ecoflex (k_{Ecoflex}) is directly calculated using this equation. Since bare epoxy and composites are enclosed between the silicone rubber discs, the thermal resistance in series (R) (Equation 2) is defined by the geometry, where each resistor is defined by the thickness of the sample (L) divided by the cross-sectional area perpendicular to the path (A) and the thermal conductivity of the sample (k) (Equation 3). To calculate the thermal conductivity of the composites (k_{comp}), the effective thermal conductivity (k_{eff}) comprising the complete set (composite between Ecoflex discs) was measured. Using equation 3 in 2, it is possible to find the thermal conductivity of the composite (k_{comp}).

$$Thermal conductivity \\ k = \frac{Q \times L}{Δ T} . \qquad Equation 1$$

$$Thermal resistance in series \\ {R}_{eff} = 2 {R}_{Ecoflex} + {R}_{comp} . \qquad Equation 2$$

$$Thermal resistance \\ R = \frac{L}{A \times k} . \qquad Equation 3$$

FIG. 12B summarizes the results for the thermal conductivity of nanocomposites. Three specimens of each concentration were analyzed to generate the error bars. Typically, epoxy resin has a thermal conductivity of ˜0.2 W/mK depending upon formulation and precursors. The use of a co-solvent to improve dispersibility in the matrix, inhibit the formation of a nanoparticle network constraining the phonon transport across the PDA nanoparticles. Therefore, the overall thermal conductivity of the nanocomposite is not affected. At very high filler content, the nanoparticles can form a network affecting the thermal conductivity of the nanocomposite while, at low concentrations, the fillers are isolated by the matrix, unaffecting the thermal conductivity of the system. From FIGS. 7C and 12B, even at the maximum concentration (20 wt. %) of PDA, the percolation limit has not been achieved, leaving the thermal conductivity properties of the nanocomposite unaffected.

When a material is heated above room temperature, it will start losing heat by conduction, convection, and radiation; latter referring to the emissivity. The emissivity of the surface of a material is directly related to the ability of the surface to emit energy as thermal radiation. Usually organic materials have high emissivity (˜1.00), while the polished metal and reflective surfaces tend to have a low emissivity. The emissivity of a material also depends on its specific chemistry and surface characteristics. Smooth, shiny surfaces, for example, exhibit higher reflectivity and low emissivity. FIG. 12B, presents the emissivity of epoxy nanocomposites as a function of PDA nanoparticles concentration. The epoxy resin emissivity was calculated along with the epoxy-PDA nanocomposites using a forward looking infra-red (FLIR) thermal camera and black electrical insulating tape (3M™) with known emissivity (0.96) (FIG. 13). As was expected, the variation of PDA concentration in the matrix does not significantly change the emissivity of bare epoxy.

### 4. PHOTOTHERMALLY RESPONSIVE MELANIN-BASED NANOCOMPOSITES

The results from our heating/cooling experiments led us to a realization that by manipulating the concentration of PDA in the polymeric matrix, specific regions of the matrix can be tuned to photothermally absorb more or less energy. This would in turn affect the radiative properties of the different regions of the sample that can only be perceived using a thermal camera. To test this idea, a pattern made of epoxy with higher PDA concentration (5 wt. %) was generated and then embedded into an epoxy matrix doped with a lower PDA concentration (1 wt. %). Irradiation with solar IR lamp, produced a differential photothermally-absorbed region which when viewed under a naked eye looked indifferent, but under a FLIR thermal camera the pattern (hotter that the surrounding matrix) showed up clearly (FIG. 3B). Such a tuning of thermal radiative properties is desired for applications involving anti-counterfeiting, concealed patterns/messages, infrared communication, and sensors. Intricate patterns can also be fabricated by the same methodology as mentioned previously. Countless pattern-embedded discs show the same characteristics as the previous example (FIG. 4A-B).

### 5. PHOTOTHERMALLY RESPONSIVE PAINTS

PDA nanoparticles can be also dispersed in paint vehicles i.e., transparent varnish. The concentration of PDA granules will dictate the amount of energy absorbed from the light source. At a higher concentration of synthetic melanin in the matrix, higher the temperature reached.

FIG. 1A shows strokes made on a white paper using a paint brush employing different concentrations (1, 5, 10 and 20 wt. %) of PDA in a transparent varnish. Note that like the previous demonstrations using the discs, irrespective of the pigment concentration, all the strokes look the same dark.

The brush strokes were irradiated by an IR lamp and the temperature reached was recorded. After 15 seconds a significant difference in temperature was achieved (FIG. 1B). Under naked eye, it is not possible to distinguish the concentration of the strokes on a white paper, but when exposed to an IR light source, they will absorb different amount of energy that one can observe with the aid of a thermal imaging camera.

FIGS. 2A-B demonstrates the applicability of the previous discovery. Part of a white paper was first covered with a low concentration of PDA (1 wt. %) in a clear varnish. Once dry, on this new surface, the word “UAKRON” was written with a fine brush using a higher concentration suspension of PDA (20 wt. %) in the varnish. FIG. 2A illustrates how the written pattern is indistinguishable by our eyes. When irradiated by the IR lamp, the pattern, which contains a higher amount of PDA, will heat up more than the base coating. This differential heating can be easily detected by the infrared camera (FIG. 2B).

### 6. CONCLUSIONS

The present invention presents a facile method to disperse high amount of PDA nanoparticles in a polymeric matrix using a co-solvent. It has been found that the thermal properties like emissivity and thermal conductivity do not change when increasing the concentration of PDA in the matrix. However, tuning the PDA concentration in a polymeric matrix allows controlling the extent of photothermal heating. To support experimental observations, initial simulations were performed on these nanocomposites to model and predict how the photothermal absorption changes as a function of nanoparticle concentration in the base matrix.

In addition, the present invention provides a way to pattern information by means of differential photothermally-absorbed regions that can be achieved using varying the doping concentrations of PDA in molded discs and inks, yielding a significant temperature difference between the two upon exposure to solar IR lamp radiation. Only a thermal camera can show this difference making the hidden pattern visual.

### EXAMPLES

The following examples are offered to more fully illustrate the invention but are not to be construed as limiting the scope thereof. Further, while some of examples may include conclusions about the way the invention may function, the inventor does not intend to be bound by those conclusions but put them forth only as possible explanations. Moreover, unless noted by use of past tense, presentation of an example does not imply that an experiment or procedure was, or was not, conducted, or that results were, or were not actually obtained. Efforts have been made to ensure accuracy with respect to numbers used (e.g., amounts, temperature), but some experimental errors and deviations may be present. Unless indicated otherwise, parts are parts by weight, molecular weight is weight average molecular weight, temperature is in degrees Centigrade, and pressure is at or near atmospheric.

### Example 1

### Preparation of Epoxy-PDA Composite

The synthesis of PDA nanoparticles was carried out using a modified procedure through the oxidative polymerization of dopamine monomers in a solution of water, ethanol and ammonia at 45° C. to synthesize PDA nanoparticles, 600 mg of dopamine hydrochloride was added to a 150 mL of water and 60 mL of ethanol mixture, fully mixed with 120 μL of ammonium hydroxide (NH₄OH) solution (28-30 wt. %) under continuous stirring at 45-50° C. It was observed that the solution turned yellow instantaneously and later gradually changed to black after 2 h. Chemicals for PDA nanoparticles synthesis were purchased from Sigma-Aldrich.

The PDA nanoparticles were redispersed in isopropanol (IPA), where the precursors of the epoxy resin are soluble. Four different amount of PDA nanoparticles were added to the epoxy resin, producing four concentrations of epoxy-PDA composite, 1, 5, 10 and 20 wt. %. The PDA suspension and the resin precursors are mixed mechanically in the presence of IPA, until a homogeneous suspension is achieved, then the IPA is extracted by vacuum, leaving a well dispersion of PDA in the polymeric matrix which is poured in Polytetrafluoroethylene (PTFE) molds (discs of 1 inch diameter and 2 mm depth), the mixture is cured for 24 hours to finally get a hard composite (FIG. 5). Three discs are made for each concentration to ensure the reproducibility of the experiments. Art Resin™ is used as epoxy resin which is composed of bisphenol-A-(epichlorohydrin), Dodecyl and tetradecyl glycidyl ethers and, Poly(propylene glycol) bis(2-aminopropyl ether).

### Example 2

### Thermal Conductivity Analysis

To measure the thermal conductivity of Epoxy-PDA composites, a temperature gradient was established across the sample by heating the upper plate to approximately 30′C and the lower plate to approximately 40° C. of a custom-built heat flux meter (FIG. 12A). The equipment was built to comply with the American Society for Testing and Materials (ASTM) Standard C518-10. Custom heat flux sensors (International Thermal Instrument Company Inc, Del Mar, Calif., USA) were attached into the upper and lower plates to measure the heat flux and temperature on both sides of the sample. The custom heat flux meter was calibrated using PDMS Sylgard 528 having a thermal conductivity of 0.128 W/mK. Typical thermal conductivity for poly(dimethylsiloxane), such as the elastomer used in calibration, was 0.15 W/m K, varying slightly from the value because of its specific composition. Samples were required to be 1-in-diameter circles to completely cover the heat flux sensors for proper testing. To avoid air gaps between the epoxy composite and the flux sensors, the epoxy disc was placed between two Ecoflex™ OO-30 silicone rubber discs of the same dimensions and thickness. Three samples of each Epoxy-PDA composite concentration were prepared for testing. Composite samples and silicone rubber discs thickness where around 2 mm.

Through testing, the temperatures and heat flux on both sides of the sample were collected continuously at 1 Hz using Tracer DAQ (Measurement Computing, Norton, Mass., USA). Each sample was tested for at least 6 hours to reach a steady state, defined as reading fluctuations neither greater than 100 m ° C. nor 100 μV over a period of 30 minutes. Final temperature and heat flux measurements were taken once each sample reached a steady state. The sample thickness (L) was measured using a digital indicator (Mitutoyo America, Aurora, Ill., USA), and then it was used along with the average heat flux (Qavg) and temperature difference (ΔT) across the sample to calculate the thermal conductivity (K). The results are shown in FIG. 12B.

### Example 3

### Emissivity Analysis

A small piece of black electrical insulating tape (3M™) with known emissivity (0.96) was attached on a side of the surface of the disc (FIG. 13), covering a small portion of the surface. The sample was placed on a hot plate which was heated up to 40° C. The temperature of the sample was allowed to equilibrate during 10 min before taking any data. A thermal camera (FLIR IR T430sc, FLIR Systems, USA) was placed vertically over the sample to a distance of 30 cm. For temperature readouts, a defined area of the sample and tape was considered, then using the software FLIR Tools the emissivity of the bare sample was changed to match the tape's temperature, finding the emissivity value of the composites. The results are shown in FIGS. 12B and 13.

### Example 4

### Heating and Cooling Cycle Analysis

Each sample is placed in a box to avoid air currents, where a wire grid acting as a support hold the discs. The samples are irradiated during 10 min using a solar IR lamp (250 Watt Red Infrared Heat Lamp Bulb G E) with a power of 1000 W/m², an intensity that can be reached during a clear sunny day. Then the lamp is shut down for another 10 min, allowing the samples to cool down. During each heating and cooling cycle, the temperature is recorded using the thermal camera every minute for three specimens of each concentration to calculate standard deviation. The results are shown in FIG. 10.

### Example 5

### Hidden Pattern Experiments

A 3D printer is used to generate the molds that were then filled with the epoxy with higher PDA concentration (5 wt. %), then the design is cured at room temperature for 24 hours. An epoxy matrix doped with a lower PDA concentration (1 wt. %) is prepared and the model made previously is embedded in it. The whole system is also cured for 24 hours (FIGS. 3A-B, 4). Upon irradiation with solar IR lamp, a differential photothermally-absorbed region was produced which when viewed under a naked eye looked indifferent, but under a FLIR thermal camera the pattern (hotter that the surrounding matrix) showed up clearly.

This idea has been extended by employing PDA granules dispersed in a varnish matrix. Like the previous application, higher concentrations of PDA in the varnish will heat up more that lower concentrations. 1 wt. % PDA dispersed in the varnish was used to paint a white paper, after drying, the word “UAKRON” was written using a paint brush on the new black substrate employing an ink with a 20 wt. % PDA concentration. The pattern is invisible to the naked eyes. After the system was dried, it was exposed to the IR lamp where the pattern shows up after 15 second approximately. The results are shown in 1A-B and 2A-B.

### Example 6

### Finite-Difference Time-Domain FDTD

The optical absorption of different types of epoxy nanocomposites were simulated by performing three-dimensional FDTD calculations using a commercial-grade Ansys Lumerical 2021 R1 FDTD solver (Ansys, Inc). The synthetic melanin particle distribution for varying concentrations (as shown in the CAD schematics in FIG. 11A) followed a “uniform random” distribution with no overlaps. These particles were embedded in a rectangular block (4.5 μm×4.5 μm×10 μm), designated with the material properties of epoxy. The optical constants used in the simulations for synthetic melanin and epoxy can be found in the previous literature. The simulations were running at normal incidence using a broadband plane wave source (360 nm-1700 nm), propagating along the −Z direction. Boundary conditions in the lateral dimension (X and Y) were set to periodic. Adequate simulation time (in fs) were ensured and boundary conditions along the light propagation direction (Z; perfectly matching layer (PML) boundaries) were chosen such that the electric field decayed before the end of the simulation (auto-shutoff criteria) and that all the incident light was either reflected, transmitted, or absorbed. The absorption spectra were calculated from the reflectance and transmittance data collected using the Discretized Fourier Transform (DFT) power monitors.

This study used the following parametric values to set-up the optical simulations: a) an auto non-uniform mesh type with a mesh accuracy of 4 (18 mesh points per wavelength), minimum mesh step of 0.25 nm, and inner mesh size of ˜12 nm for the structural part of the simulation box, b) a source injection plane at ˜1.5 μm above the surface of the nanocomposite, c) a stretched-coordinate PML boundary (steep-angle type) with 32 layers in the direction of propagation of incident light (Z plane) arranged ˜2.5 μm behind the source injection place, d) a reflectance DFT monitor was set at ˜1.5 μm behind the source injection plane, and e) a transmittance DFT monitor was set at ˜3.0 μm beneath the bottom surface of the nanocomposite. The simulation times varied depending on the type of system studied and was adequately set to achieve the auto-shutoff level (a rough estimate of the energy remaining in the simulation box as a fraction of power injected), maintained at 10⁻⁵ to trigger the end of simulation upon achieving full decay. The simulated absorption spectra presented throughout the study were obtained by averaging the results obtained using both p- and s-polarization states of incident light. The results are shown in FIG. 11B.

### Example 7

### Photothermal Responsive Paints

To demonstrate the applicability of the invention to inks and paints, PDA nanoparticles were dispersed in transparent varnish, a conventional a paint vehicle, at concentrations of 1 wt. %, 5 wt. %, 10 wt. % and 20 wt. %, and evaluated.

In a first set of experiments, different concentrations (1, 5, 10 and 20 wt. %) of PDA in a transparent varnish matrix were applied to a white paper using a paint brush. As can be seen in FIG. 1A, all of the brush strokes look the same (dark), irrespective of the PDA concentration. The white paper, and with it the brush strokes, were irradiated by an IR lamp and the temperatures were viewed and recorded for each concentration of PDA using a thermal imaging camera. After only about 15 seconds a significant difference in temperature between painted and non-painted areas was achieved for all PDA concentrations (FIG. 1B), as well as differences in temperature between the different concentrations of PDA. By the naked eye, it is not possible to distinguish the PDA concentrations of the strokes on a white paper, but when they are illuminated with an IR light source, they are clearly distinguishable with the aid of a thermal imaging camera. As expected, it was found that concentration of PDA nanoparticles in the matrix will dictate the amount of energy absorbed from the light source. That is, the higher concentration of synthetic melanin in the matrix, the higher the temperature reached when exposed to light.

In a second set of experiments, part of a sheet of white paper is first covered with a low dispersion concentration of PDA (1 wt. %) in the varnish. Once the surface was dry, the word “UAKRON” was written with a fine brush on the new surface using a higher concentration of PDA (20 wt. %) in the varnish. FIG. 2A illustrates how the written pattern is indistinguishable by the naked eye from the background. It is believed that this is because the two concentrations are the same color and do not present a contrast that the eye can perceive.

However, the work “UAKRON” is clearly apparent using a thermal imaging camera when the system is irradiated by an IR lamp, as shown in FIG. 2A. The “UAKRON” pattern, which contains a higher amount of PDA, heats up more than the surface where it is written. This phenomenon is easily detected by the infrared camera as shown in FIG. 2B.

In light of the foregoing, it should be appreciated that the present invention significantly advances the art by providing a photothermal-responsive melanin-based nanocomposite that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A photothermal-responsive melanin-based nanocomposite comprising a plurality of natural or synthetic melanin nanoparticles and a polymer matrix.

2. The photothermal-responsive melanin-based nanocomposite of claim 1 wherein the temperature of the nanocomposite increases when it is exposed to light.

3. The photothermal-responsive melanin-based nanocomposite of claim 1 wherein said plurality of natural or synthetic melanin nanoparticles comprise polydopamine (PDA) nanoparticles.

4. The photothermal-responsive melanin-based nanocomposite of claim 1 wherein said plurality of natural or synthetic melanin nanoparticles have a diameter of from about 10 nm to about 500 nm.

5. The photothermal-responsive melanin-based nanocomposite of claim 1 wherein the concentration of said plurality of natural or synthetic melanin nanoparticles in the polymer matrix is from about 0.10% to about 40 wt. %.

6. The photothermal-responsive melanin-based nanocomposite of claim 1 wherein said plurality of natural or synthetic melanin nanoparticles are substantially homogeneously distributed throughout the polymer matrix.

7. The photothermal-responsive melanin-based nanocomposite of claim 1 wherein the polymer matrix is selected from the group consisting of epoxy, polystyrene, acrylates, polyurethanes, poly(lactic acid), polyolefins, vinyls (polyvinyl alcohol), polysiloxanes (PDMS), rubbers and elastomers, and combinations thereof.

8. An ink, paint, or coating comprising the photothermal-responsive melanin-based nanocomposite of claim 1.

9. The ink, paint, or coating of claim 8 wherein the temperature of the ink, paint, or coating increases when it is exposed to light.

10. The ink, paint, or coating of claim 8 wherein the polymer matrix is an ink vehicle or binder or a paint vehicle or binder.

11. The ink, paint, or coating of claim 8 wherein the polymer matrix is selected from the group consisting of transparent varnish (alkyds), polyethylene glycols, acrylics, polyurethanes, cellulosics, epoxies, and combinations thereof.

12. The ink, paint, or coating of claim 8 wherein the polymer matrix is a clear varnish.

13. The ink, paint, or coating of claim 8 wherein the said plurality of natural or synthetic melanin nanoparticles comprises polydopamine (PDA) nanoparticles.

14. The ink, paint, or coating of claim 8 wherein the concentration of the plurality of natural or synthetic melanin nanoparticles in the polymer matrix is from about 0.10% to about 40 wt. %.

15. A written message, comprising symbols and/or letters, or a design formed using one or more of the photothermal-responsive melanin-based nanocomposites of claim 1 wherein said written message or design are visible using an infrared camera when the written message is exposed to light.

16. The written message, comprising symbols and/or letters, or a design of claim 15 wherein the one or more photothermal-responsive melanin-based nanocomposites are one or more of the inks, paints, or coatings of claim 8.

17. The written message, comprising symbols and/or letters, or a design of claim 15 comprising two or more of the photothermal-responsive melanin-based nanocomposites of claim 1, each of said two or more photothermal-responsive melanin-based nanocomposite having a different melanin nanoparticle concentration.

18. The written message, comprising symbols and/or letters, or design of claim 17 comprising a first photothermal-responsive melanin-based nanocomposite having a first melanin nanoparticle concentration and a second photothermal-responsive melanin-based nanocomposite having a second and higher melanin nanoparticle concentration.

19. The written message, comprising symbols and/or letters, or design of claim 18 wherein the difference between said first melanin nanoparticle concentration and said second and higher melanin nanoparticle concentration is from about 0.25 wt. % and about 10 wt. %.

20. A sensor comprising photothermal-responsive melanin-based nanocomposite of claim 1.

21. A method for confirming the authenticity of a product using the photothermal-responsive melanin-based nanocomposite of claim 1 comprising:
A) preparing a photothermal-responsive melanin-based nanocomposite according to claim 1 by distributing a plurality of natural or synthetic melanin nanoparticles throughout a polymer matrix;
B) applying the photothermal-responsive melanin-based nanocomposite of step A to a pre-determined area on authentic products and allowing it to dry or harden;
C) obtaining a product that may or may not be authentic;
D) exposing an area of the product of step C that includes at least a portion of the predetermined area to which the photothermal-responsive melanin-based nanocomposite has been applied and a comparable portion of the product outside said predetermined area to a light source; and
E) measuring the temperature of the product of step D where it was exposed to the light to determine if the temperature of the product is higher in the predetermined areas to which the photothermal-responsive melanin-based nanocomposite was applied than in comparable area of the product outside said predetermined area;
wherein the authenticity of the product may be confirmed if the measured temperature of the product is higher in the predetermined areas to which the photothermal-responsive melanin-based nanocomposite was applied than in comparable areas of the product outside said predetermined area.

22. The method of claim 21 wherein the presence of the photothermal-responsive melanin-based nanocomposite on the authentic product is not visible.

23. The method of claim 21, wherein the areas of the product to which the photothermal-responsive melanin-based nanocomposite have been applied and comparable area to which the photothermal-responsive melanin-based nanocomposite have not been applied are visually indistinguishable.

24. The method of claim 21 wherein the concentration of the plurality of natural or synthetic melanin nanoparticles in the photothermal-responsive melanin-based nanocomposite is from about 0.10% to about 40 wt. %.

25. The method of claim 21 wherein the step of applying (step B) comprises applying the written message, comprising symbols and/or letters, or design of claim 15 to the pre-determined area.

26. The method of claim 21 wherein the step of measuring the temperature (step E) is performed using a thermal imaging camera.

27. The method of claim 21, wherein the light source produces light having wavelengths from about 290 nm to about 1200 nm.

28. The method of claim 21 wherein the light source is a broadband solar lamp.

29. The method of claim 21 wherein the light source is an infrared (IR) solar lamp.
